(19) United States
(12) Patent Application Publication
(10) Pub. No.: US 2003/0108004 A1
(43) Pub. Date: Jun. 12, 2003

(54) Method of transmitting data in packets with a symmetrical switching spectrum

(75) Inventors: Pierre Kolodziej, Bagneaux/Loing (FR); Mikael Pouliquen, Paris (FR)

Correspondence Address: SUGHRUE, MION, ZINN,, MACPEAK & SEAS, PLLC, Suite 800, 2100 Pennsylvania Avenue, N.W., Washington, DC, 20037-3213, US

(73) Assignee: ALCATEL

(21) Appl. No.: 10/206,949

(22) Filed: Jul. 30, 2002

(30) Foreign Application Priority Data
Aug. 9, 2001 (FR) 01 10 646

(51) Int. Cl. H04B 7/212

(52) U.S. Cl. 370/321; 370/347

(57) ABSTRACT

In a method of transmitting, between a mobile terminal and a base station in a mobile radio network, data bursts comprising a header and a tail respectively associated with the rising and falling transitions of the burst, each burst being situated in a slot centered on a send/receive frequency, the header and the tail of a burst are made up of sequences of bits with different values so that the frequency spectrum associated with the transitions is centered on the send/receive frequency.

### CROSS-REFERENCE TO RELATED APPLICATIONS

This application is based on French Patent Application No. 01 10 646 filed Aug. 9, 2001, the disclosure of which is hereby incorporated by reference thereto in its entirety, and the priority of which is hereby claimed under 35 U.S.C. §119.

### BACKGROUND OF THE INVENTION

1. Field of the Invention

The present invention relates to communication by radio between mobile stations and base stations by sending and receiving packets of data also known as bursts.

2.Description of the Prior Art

Transmission in bursts is imposed by the transmission constraints of time division multiple access (TDMA) and frequency division multiple access (FDMA) transmission. The Global System for Mobile communications (GSM) standard specifies a combination of TDMA and FDMA techniques for managing radio transmission by mobile terminals on appropriate frequencies during particular time periods. The same applies to the Digital Communications System (DCS) standard, which relates to the same operating principle as the GSM standard, but a different band of frequencies, namely 1 800 MHz instead of 900 MHz in the case of the GSM.

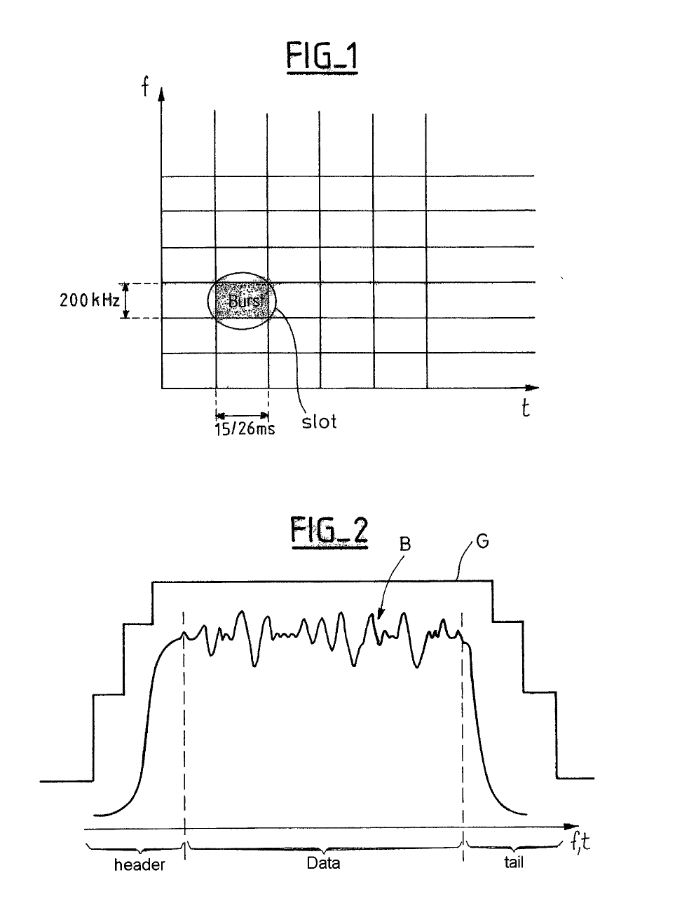

The basic element of radio transmission in accordance with the GSM standard is the burst, which is a unit of data transmission and contains approximately 100modulated data bits. As shown in FIG. 1, a burst has a particular duration and occupies a particular portion of the frequency spectrum. During a call, a burst is transmitted at a particular frequency in a time slot. To be more precise, according to the GSM standard, for example, the center frequencies of the time slots are spaced by 200 kHz in the frequency domain and occur every 0.577 ms or 15/56 ms in the time domain.

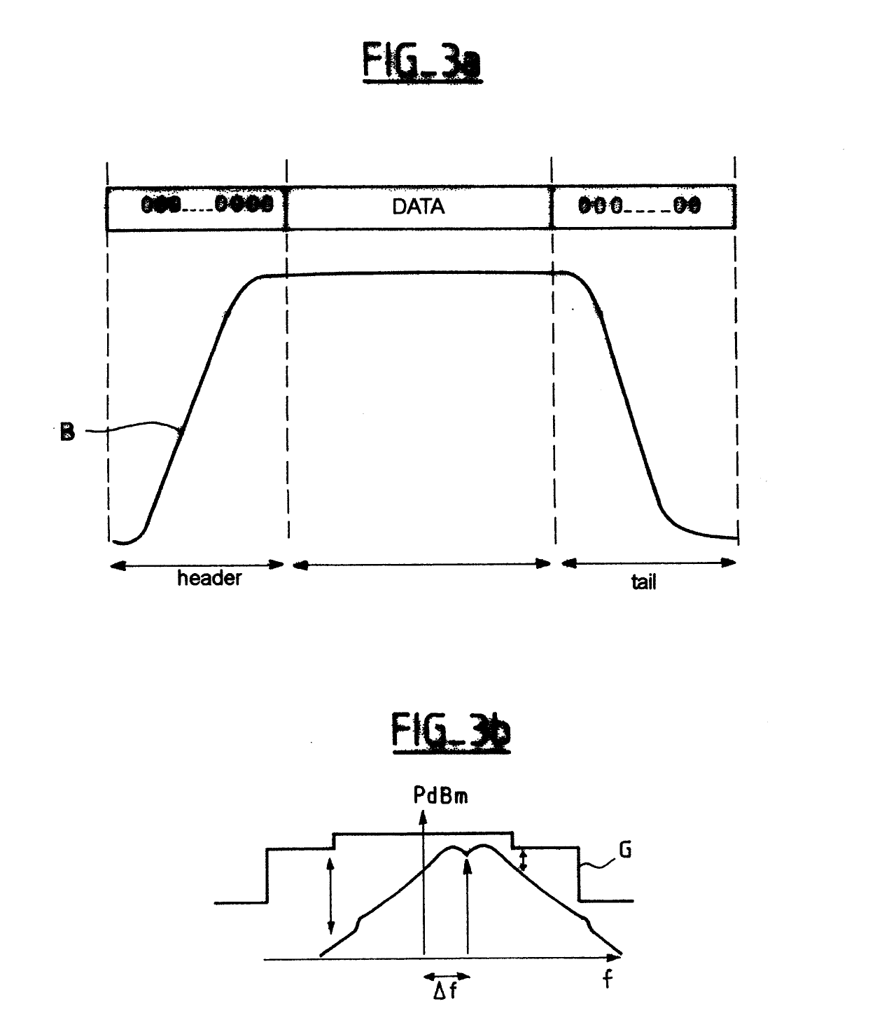

FIG. 2 shows diagrammatically a burst in the time domain t or the frequency domain f. A burst B includes a header corresponding to the rising transition and a tail corresponding to the falling transition, the modulated data to be transmitted being sent or received in the central portion of the burst B. The data is modulated simultaneously in the time domain and in the frequency domain. The burst B must also fit inside a template G imposed by the standards. This template is symmetrical with respect to the send/receive frequency and with respect to the allocated time slot. The GSM standard further specifies that all the frequency spectra be symmetrical with respect to the center send/receive frequency and fit inside the template G.

The mobile terminals and the base stations have onboard burst sending software. The software is designed to fill the bursts, as previously defined, with the payload data to be transmitted. As shown in FIG. 3a, the conventional software fills the header and the tail of the burst with zero bits since no data is transmitted during these transitions.

However, as shown in FIG. 3b (power as a function of frequency), a set of zero bits induces a shift of the frequency spectrum corresponding to the transition period of the burst and encroaches on the usable margin in the imposed template. In effect, Gaussian minimum shift keying (GMSK), a form of frequency modulation, is applied to the whole of the burst and therefore also affects the transitions, i.e. the header and the tail of the burst. This GMSK modulation induces a shift of π/2 distributed over a period of 3 bits. Thus each preceding bit influences the modulation of the following bit. In a succession of zero bits the phase always rotates in the same direction and induces a frequency shift. In the case of GSM transmission, for example, the burst frequency template is centered on 1 747 kHz and the shift of the frequency spectrum of the transitions of the burst can be as much as Δf=67 kHz, which can cause the transition spectrum to depart from the template, for example in the event of particular climatic constraints. Any such departure from the template specified by the GSM standard can cause interference with transmission of a burst in another time slot.

Recentering the spectrum by software can be envisaged, but is often insufficient.

An objective of the present invention is to solve this problem of the frequency shift in the transition spectrum of the burst. Thus an object of the invention is to propose a burst transmission method in which the frequency spectrum of the transition period is symmetrical with respect to the center send/receive frequency and thus symmetrical with respect to the template of the burst.

### SUMMARY OF THE INVENTION

The invention provides a method of transmitting, between a mobile terminal and a base station in a mobile radio network, data bursts comprising a header and a tail respectively associated with the rising and falling transitions of the burst, each burst being situated in a slot centered on a send/receive frequency, in which method the header and the tail of the burst are made up of sequences of bits with different values so that the frequency spectrum associated with the transitions is centered on the send/receive frequency.

In a first embodiment the sequences of bits constituting the header and the tail of the burst are periodic.

According to one feature the sequences of bits are made up of successive ‘01’ values.

In a second embodiment the sequences of bits constituting the header and the tail of the burst are pseudo-random.

In a third embodiment the sequences of bits constituting the header and the tail of the burst evolve between two successive bursts.

In the embodiments the evolution of the sequences of bits constituting the header and the tail of successive bursts consists in a translation or a circular permutation.

The invention also provides a mobile radio terminal adapted to transmit data bursts each situated in a slot centered on a send/receive frequency, the terminal including onboard software adapted to fill the bursts with data and which fills the header and the tail of the burst with sequences of bits having different values so that the switching spectrum of the bursts is centered on the send/receive frequency.

The invention further provides a base station associated with a mobile radio network for transmitting data bursts each situated in a slot centered on a send/receive frequency, the base station including software adapted to fill the bursts with data and which fills the header and the tail of the burst with sequences of bits having different values so that the switching spectrum of the bursts is centered on the send/receive frequency.

The present invention will be better understood on reading the following description, which is given by way of illustrative and non-limiting example and with reference to the accompanying drawings.

BRIEF DESCRIPTION OF THE DRAWINGS

FIG. 1, already described, shows burst transmission in a time and frequency slot according to the GSM standard.

FIG. 2, already described, shows a burst diagrammatically.

FIG. 3a, already described, shows a prior art burst.

FIG. 3b, already described, shows the frequency spectrum of the transitions of the FIG. 3a burst.

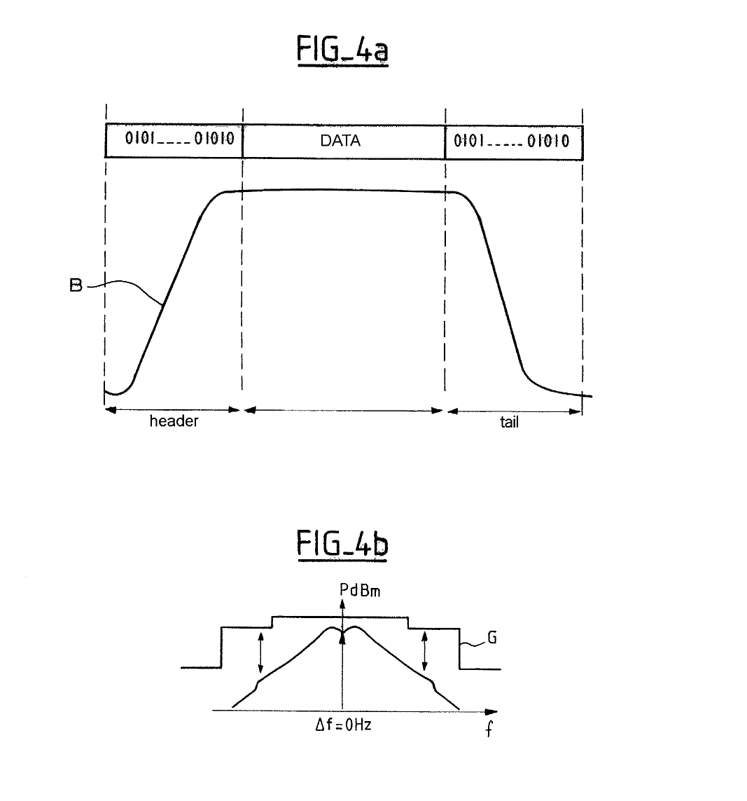

FIG. 4a shows a first embodiment of a burst according to the invention.

FIG. 4b shows the frequency spectrum of the transitions of the FIG. 4a burst.

FIG. 5 shows the frequency spectra of transitions of a second embodiment of a burst according to the invention.

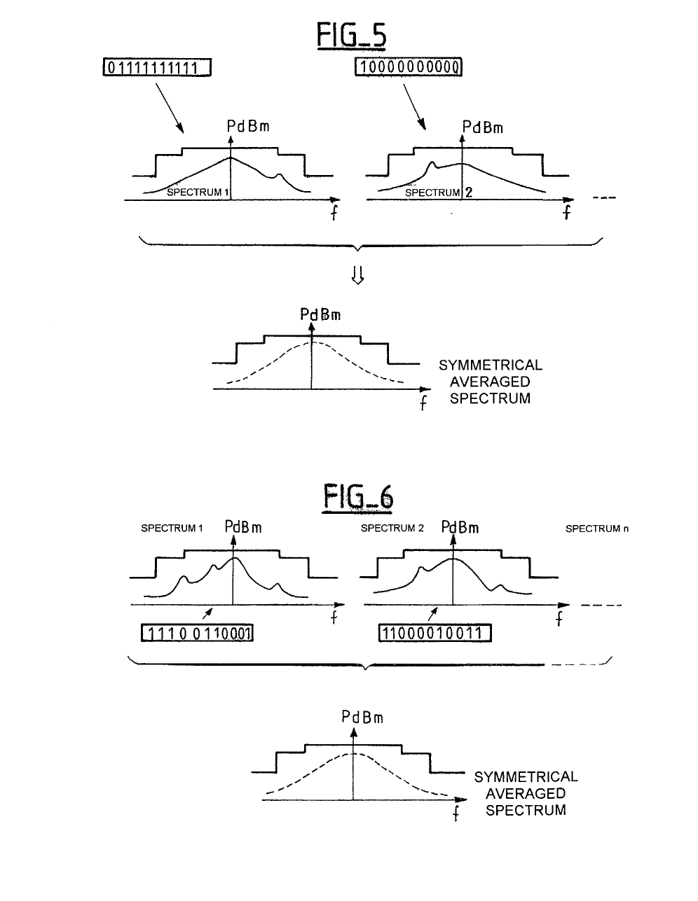

FIG. 6 shows the frequency spectra of transitions of a third embodiment of a burst according to the invention.

### DETAILED DESCRIPTION OF THE PREFERRED EMBODIMENTS

Referring to FIGS. 4 to 6, the header and the tail of a burst B in accordance with the invention are made up of successive sequences of bits with different values chosen to allow GMSK modulation with no frequency shift.

These sequences of bits with different values according to direction are created by software in the mobile terminals and in the base stations to fill the bursts with data. The software is conventional, but includes specific sequences for implementing the invention.

In a first embodiment of the invention, shown in FIG. 4a, the header and the tail of the burst B are made up of a succession of periodic sequences of bits with different values, for example a succession of ‘01’ values. Such values allow GMSK modulation with no frequency shift and therefore remaining centered on the send frequency. In effect, a succession of periodic frequencies of bits with different values compensates the direction of the phase shift and therefore the frequency shift at each modulated bit.

FIG. 4b shows the transition frequency spectrum obtained with a burst header and tail made up of successive sequences of periodic bits conforming to the invention. The frequency spectrum of the transitions of the burst is therefore largely contained within the template G with substantial margins on either side of the spectrum to accommodate any fluctuations without risk of interfering with the sending or receiving of another burst.

In a second embodiment of the invention, shown in FIG. 5, the header and the tail of the burst B are made up of a succession of sequences of bits with different pseudo-random values, such as a succession of ‘0’ bits with one ‘1’ bit, for example, or vice-versa. Such values enable correction of the frequency shift observed over a plurality of bursts by an average of the GMSK modulation of each burst. In effect, at the time of modulation, this kind of succession of values of modulation bits raises the spectrum of the frequency corresponding to the ‘1’ bit. The location of this ‘1’ bit varies from one burst to another and produces a frequency spectrum smoothed over the average of the frequency modulations of a plurality of bursts.

In a third embodiment of the invention, shown in FIG. 6, the header and the tail of the burst B are made up of a succession of sequences of bits with different values that evolve from one burst to another, such as by translation or by circular permutation of the values of the bits constituting said sequences. Evolving sequences of this kind also allow correction of the frequency shift observed over a plurality of bursts by an average of the GMSK modulation of each burst.

There is claimed:

1. A method of transmitting, between a mobile terminal and a base station in a mobile radio network, data bursts comprising a header and a tail respectively associated with the rising and falling transitions of the burst, each burst being situated in a slot centered on a send/receive frequency, in which method the header and the tail of a burst are made up of sequences of bits with different values so that the frequency spectrum associated with said transitions is centered on said send/receive frequency.

2. The transmission method claimed in claim 1 wherein said sequences of bits constituting said header and said tail of said burst are periodic.

3. The transmission method claimed in claim 2 wherein said sequences of bits are made up of successive ‘01’ values.

4. The transmission method claimed in claim 1 wherein said sequences of bits constituting said header and said tail of said burst are pseudorandom.

5. The transmission method claimed in claim 1 wherein said sequences of bits constituting said header and said tail of said burst evolve between two successive bursts.

6. The transmission method claimed in claim 5 wherein the evolution of said sequences of bits constituting said header and said tail of successive bursts consists in a translation of the values of said bits.

7. The transmission method claimed in claim 5 wherein the evolution of said sequences of bits constituting said header and said tail of two consecutive bursts consists in a circular permutation of the values of said bits.

8. A mobile radio terminal adapted to transmit data bursts each situated in a slot centered on a send/receive frequency, said terminal including onboard software adapted to fill said bursts with data and which fills said header and said tail of said burst with sequences of bits having different values so that the switching spectrum of said bursts is centered on said send/receive frequency.

9. A base station associated with a mobile radio network for transmitting data bursts each situated in a slot centered on a send/receive frequency, said base station including software adapted to fill said bursts with data and which fills said header and said tail of said burst with sequences of bits having different values so that the switching spectrum of said bursts is centered on said send/receive frequency.
